(19) United States
(12) Patent Application Publication
(10) Pub. No.: US 2026/0335918 A1
(43) Pub. Date: Oct. 29, 2026

(54) ARTIFICIAL INTELLIGENCE-ENABLED SMART SPRAYER SYSTEM

(71) Applicant: University of Florida Research Foundation, Incorporated, Gainesville, FL (US)

(72) Inventors: Vinay Vijayakumar, Naples, FL (US); Antonio de Oliveira Costa Neto, Immokallee, FL (US); Ioannis Ampatzidis, Immokallee, FL (US)

(21) Appl. No.: 19/661,001

(22) Filed: Apr. 28, 2026

Related U.S. Application Data
(60) Provisional application No. 63/796,661, filed on Apr. 29, 2025.

(51) Int. Cl. B05B 12/16; G06V 10/774; G06V 20/10; G06V 20/56

(52) U.S. Cl. CPC B05B 12/16; G06V 10/774; G06V 20/188; G06V 20/56

(57) ABSTRACT

Various embodiments of the present disclosure provide methods, apparatus, systems, computing devices, computing entities, and/or the like for a smart sprayer system. The method includes configuring a detection model configured to detect at least one target agricultural subject. The method includes receiving real-time imagery depicting a subject agricultural area serviced by a sprayer system comprising a plurality of sprayer mechanisms. The method includes detecting at least one depicted target agricultural subject in the real-time imagery depicting the subject agricultural area. The method includes generating one or more localized sprayer instructions according to the at least one depicted target agricultural subject and the subject agricultural area. The method includes providing the one or more localized sprayer instructions to a sprayer mechanism. The method includes causing activation of at least one sprayer mechanism of the plurality of sprayer mechanisms based at least in part on the one or more localized sprayer instructions.

### CROSS-REFERENCES TO RELATED APPLICATIONS

The present application claims priority to U.S. Patent Application No. 63/796,661 (filed on Apr. 29, 2025), which is incorporated by reference herein in its entirety.

### GOVERNMENT LICENSE RIGHTS

This invention was made with government support under 2020-67021-30761 awarded by the United States Department of Agriculture National Institutes of Food and Agriculture. The government has certain rights in the invention.

### BACKGROUND

Various embodiments of the present disclosure address technical challenges related to systems for administering sprays to crops and other vegetation.

Undesirable vegetation (weeds, diseased vegetation, and/or the like) can pose a significant problem within the agricultural industry. Weed control and management is a significant issue in the agricultural production industry. When uncontrolled or overgrown, weeds compete with crops for sunlight, soil, nutrients, and moisture, thereby limiting the necessary resources available to crops. As such, inadequate weed control can lead to detrimental effects on crop yield and quality. Further yet, weed growth can reduce functionality, aesthetics, and surface quality of turfgrasses.

### BRIEF SUMMARY

In general, various embodiments of the present disclosure provide methods, apparatus, systems, computing devices, computing entities, and/or the like for artificial intelligence (AI)-enabled smart spray control.

In some embodiments, a computer-implemented method comprises: configuring a detection model configured to detect at least one target agricultural subject; receiving real-time imagery depicting a subject agricultural area serviced by a sprayer system comprising a plurality of sprayer mechanisms; detecting at least one depicted target agricultural subject in the real-time imagery depicting the subject agricultural area; generating one or more localized sprayer instructions according to the at least one depicted target agricultural subject and the subject agricultural area; providing the one or more localized sprayer instructions to a sprayer mechanism; and causing activation of at least one sprayer mechanism of the plurality of sprayer mechanisms based at least in part on the one or more localized sprayer instructions.

In accordance with some aspects of the present invention, detecting the at least one depicted target agricultural subject in the real-time imagery depicting the subject agricultural area includes training an object detection model to analyze the real-time imagery depicting the subject agricultural area.

In accordance with some aspects of the present invention, training the object detection model to analyze the real-time imagery depicting the subject agricultural area includes training the object detection model using a plurality of labeled training images of the at least one target agricultural subject.

In accordance with some aspects of the present invention, generating the one or more localized sprayer instructions according to the at least one depicted target agricultural subject and the subject agricultural area includes determining a location associated with the at least one depicted target agricultural subject in the real-time imagery depicting the subject agricultural area.

In accordance with some aspects of the present invention, generating the one or more localized sprayer instructions according to the at least one depicted target agricultural subject and the subject agricultural area includes generating instructions to activate the at least one sprayer mechanism of the plurality of sprayer mechanisms associated with the location associated with the at least one depicted agricultural subject.

In accordance with some aspects of the present invention, generating the one or more localized sprayer instructions according to the at least one depicted target agricultural subject and the subject agricultural area includes generating instructions to activate the at least one sprayer mechanism of the plurality of sprayer mechanisms at a predicted time at which the sprayer system is predicted to reach the at least one depicted target agricultural subject.

In accordance with some aspects of the present invention, the sprayer system is a robotic sprayer apparatus comprising one or more tires configured to navigate difficult terrain, a plurality of electronic components configured to power and control the robotic sprayer apparatus, a framework configured to accommodate raised plasticulture beds, one or more image capture devices mounted on the framework, one or more electronically controlled sprayer nozzles, one or more direct current (DC) pumps and corresponding proportional control valves, and a computing unit configured to process real-time imagery and control spraying operations.

In some embodiments, a computing apparatus comprises memory and one or more processors communicatively coupled to the memory, the one or more processors configured to perform operations comprising: configuring a detection model configured to detect at least one target agricultural subject; receiving real-time imagery depicting a subject agricultural area serviced by a sprayer system comprising a plurality of sprayer mechanisms; detecting at least one depicted target agricultural subject in the real-time imagery depicting the subject agricultural area; generating one or more localized sprayer instructions according to the at least one depicted target agricultural subject and the subject agricultural area; providing the one or more localized sprayer instructions to a sprayer mechanism; and causing activation of at least one sprayer mechanism of the plurality of sprayer mechanisms based at least in part on the one or more localized sprayer instructions.

In some embodiments, one or more non-transitory computer-readable storage media including instructions that, when executed by one or more processors, cause the one or more processors to perform operations comprising: configuring a detection model configured to detect at least one target agricultural subject; receiving real-time imagery depicting a subject agricultural area serviced by a sprayer system comprising a plurality of sprayer mechanisms; detecting at least one depicted target agricultural subject in the real-time imagery depicting the subject agricultural area; generating one or more localized sprayer instructions according to the at least one depicted target agricultural subject and the subject agricultural area; providing the one or more localized sprayer instructions to a sprayer mechanism; and causing activation of at least one sprayer mechanism of the plurality of sprayer mechanisms based at least in part on the one or more localized sprayer instructions.

### BRIEF DESCRIPTION OF THE DRAWINGS

FIG. 1 provides an example overview of a framework in accordance with some embodiments of the present disclosure.

FIG. 2 provides an example computing entity in accordance with some embodiments of the present disclosure.

FIG. 3 provides an example user computing entity in accordance with some embodiments of the present disclosure.

FIG. 4A depicts a first angle of an example smart sprayer system in accordance with some embodiments of the present disclosure.

FIG. 4B depicts a second angle of an example smart sprayer system in accordance with some embodiments of the present disclosure.

FIG. 5 depicts an example process for managing smart sprayer operation in accordance with at least some example embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

Embodiments of the present disclosure include systems, methods, computer program products, and techniques for AI-enabled smart spray applications. Such AI-enabled smart spray applications enable a smart sprayer system developed specifically for challenging agricultural conditions raised plasticulture beds and row middles (e.g., the regions between the beds) with increased efficiency, accuracy, and reliability relative to existing smart sprayer solutions.

### I. Overview, Technical Improvements, and Technical Advantages

Various embodiments of the present disclosure make important technical contributions to fields and/or environments leveraging smart sprayer application techniques.

Current sprayer system approaches struggle to operate in environments with difficult terrain. For example, agricultural arrangements such as raised plasticulture beds offer a significant obstacle to existing sprayer systems and devices, given their unique design. Existing solutions include see-and-spray technologies configured to identify weeds using computer vision and machine learning to target and spray herbicides where weeds are present. Such technologies are not configured for navigating challenging terrain or other environmental conditions, for example.

To overcome these limitations, various embodiments of the present disclosure leverage a smart sprayer system developed specifically for challenging agricultural conditions raised plasticulture beds and row middles (e.g., the regions between the beds). Embodiments of the present disclosure enable targeted applications with respect to specialty crops (such as vegetables including peppers and tomatoes, for example) grown on raised plasticulture beds and row middles, thereby addressing crops which grow in areas which are typical to manage using conventional sprayer technologies. Embodiments of the present disclosure employ a customized detection model trained on distinct weed types which are common in crop systems which reside in the described plasticulture arrangements, the distinct weed types including, but not limited to, broadleaf, sedge, and grass. Embodiments of the present invention leverage a TensorRT-optimized detection model configured to provide 22-25 FPS, thereby enabling real-time detection and localization with respect to detected weeds/invasive species. The TensorRT optimized detection model enables a high precision outcome, thereby minimizing false positives and negatives with respect to the weed detection/identification. Various embodiments of the present invention are designed to operate seamlessly in extreme weather conditions such as extreme heat, humidity, and windy conditions, for example. Further, integrated components are configured to withstand environmental stressors without compromising performance.

Various embodiments of the present disclosure are configured to spray control uniformity by maintaining a consistent pressure during operation, thereby ensuring a uniform spray pattern even under windy conditions. Further, the spray system may be optimized to operate in a small spray area, thereby minimizing drift and reducing herbicide wastage and off-target impacts. Various embodiments of the present disclosure enable dynamic height adjustment, by which the height of a spray application can be modified based on crop requirements, thereby providing flexibility for various operational scenarios.

Various embodiments of the present disclosure enable control system efficiency, improving the system’s ability to achieve a fast response time and corresponding timely application with minimal delay. The system may further be configured in a manner minimizing overshoot, thereby limiting over-application, conserving resources, and minimizing environmental impact. Various embodiments of the present disclosure provide energy-saving synchronization. The system may be configured to integrate PI controllers for pumps and proportional valves, thereby reducing the pumps’ duty cycle under idle conditions to less than 3 % and maintaining high pressure during activation.

Various embodiments of the present disclosure enable precise flow regulation and management by integrating the PI controllers for both pumps and proportional valves, thereby reducing herbicide drift and ensuring uniform coverage. By maintaining pressure within 5 % of a target pressure, the system minimizes off-target application, thereby conserving resources and minimizing surrounding environmental impacts. Various embodiments of the present disclosure integrate multiple DC pumps into the system, thereby providing an optimal balance of performance and affordability. Integrating DC pumps enables low operational costs, ease of control through PWM signals, and reliability.

### II. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### III. Example Framework

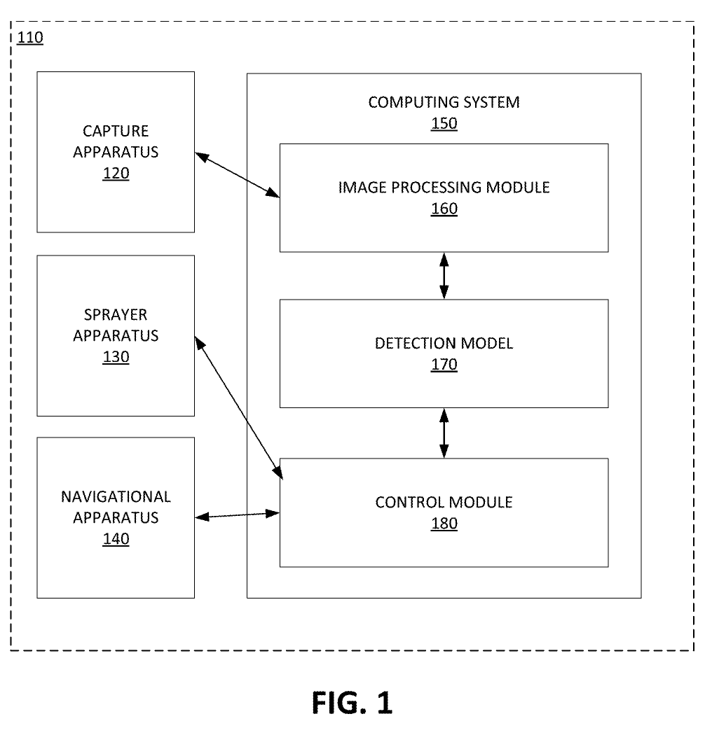

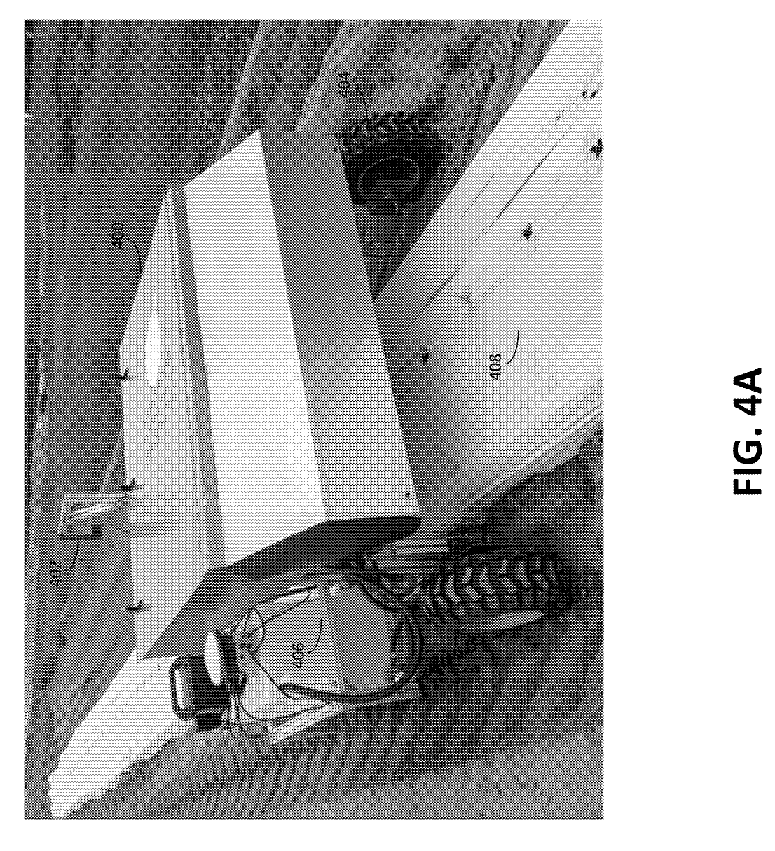

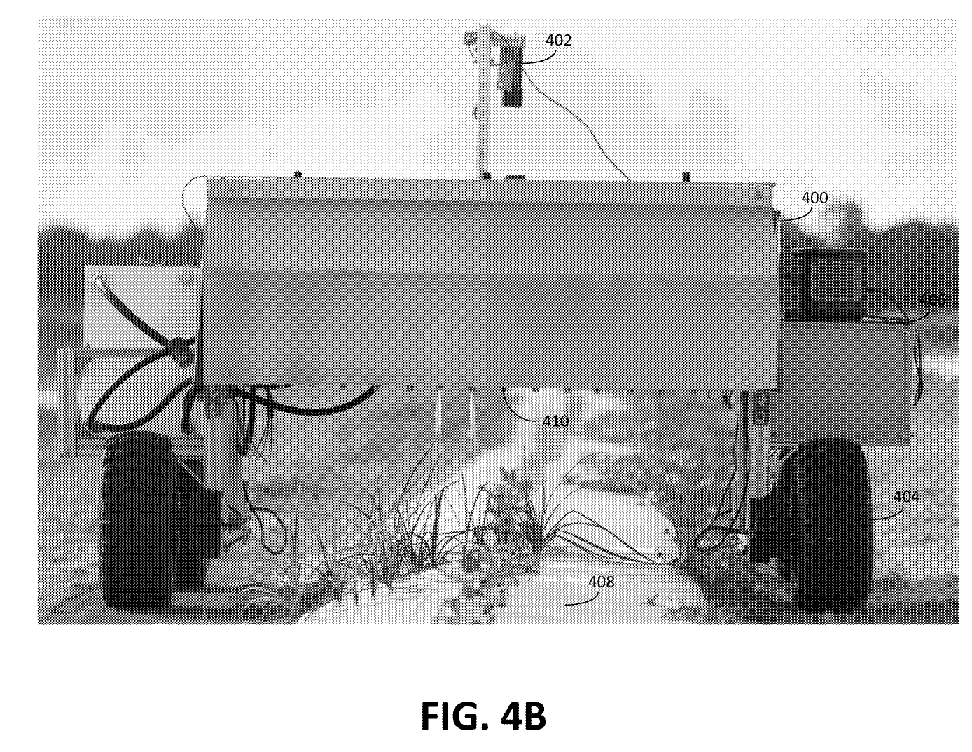

FIG. 1 provides an example overview of a framework 100 in accordance with some embodiments of the present disclosure. The framework 100 may correspond to a system for managing and administering spray treatments in an agricultural environment. In at least some embodiments, the framework 100 corresponds to a robotic apparatus comprising the aforementioned components, wherein the robotic apparatus is configured to maneuver through/across an agricultural area. In at least some embodiments, the robotic apparatus may be equipped with wheels designed to navigate difficult terrains, such as the beachy/sandy soil of some agricultural forms. In at least some embodiments, the robotic apparatus may be driven or maneuvered remotely, using a remote control and/or one or more additional control components (such as navigational apparatus 140) configured to transmit navigational instructions to one or more components controlling the movement of the framework 100. In at least some embodiments, such as those where the framework 100 is configured such that it is attached to an external apparatus (such as a tractor, for example), the framework 100 may be configured to provide pertinent navigational instructions to the external apparatus, as described below. Framework 100 may be a robotic apparatus or other vehicle configured to navigate difficult terrains and/or raised plasticulture beds and row middles, thereby enabling spray administration in locations previously inaccessible to automated sprayer systems. One example of an appropriate framework 100 is depicted with respect to FIGS. 4A and 4B.

As illustrated in FIG. l, the framework 100 includes a capture apparatus 120, a sprayer apparatus 130, a navigational apparatus 140, and a computing system 150. Capture apparatus 120 may include any tool used to capture still or moving images digitally. Capture apparatus 120 may include digital cameras, video cameras, webcams, visual scanning devices, and the like. In general, the capture apparatus 120 is configured to translate light reflected off an object into a digital or physical representation of the object. In at least some embodiments, capture apparatus 120 is configured to provide captured image data to image processing module 160. Captured image data may include one or more images, image files, video files, video file frames, and the like.

In at least some embodiments, capture apparatus 120 includes a plurality of image capture devices. In such embodiments, some of the image capture devices may capture and/or record overlapping fields of view. Capture apparatus 120 and/or computing system 150 may additionally include a storage device configured to store the captured images, video feeds, and the like. In at least some embodiments, capture apparatus 120 is configured to transmit image data to the computing system 150 and/or image processing module 160 for real-time processing. In some embodiments, capture apparatus 120 and computing system 150 are operably connected to facilitate such data transmission, while in other embodiments, such image data may be communicated via a wireless communication mechanism.

Sprayer apparatus 130 may include one or more applicators configured to address identified vegetation. In at least some embodiments, sprayer apparatus 130 includes one or more applicators configured to selectively apply steam or agrochemicals (e.g., fungicide, herbicide, and the like) to an identified target vegetation/target vegetation area. Sprayer apparatus 130 may include one or more holding tank(s), which may or may not be pressurized. In at least some embodiments, sprayer apparatus 130 includes solenoid valves, actuators, and the like to control the flow of steam and/or agrochemicals out through a nozzle. In at least some embodiments, the sprayer apparatus 130 and any corresponding applicators are configured to receive electronic signals, such as from control module 180 of computing system 150, triggering, ceasing, and otherwise managing operation of the sprayer apparatus 130.

Navigational apparatus 140 may include one or more navigational mechanisms configured to facilitate movement(s) of the framework 100. In at least some embodiments, navigational apparatus 140 includes a global positioning system (GPS) mechanism configured to generate and record location data and speed data of the framework 100. In at least some embodiments, the navigational apparatus 140 is configured to determine location information relative to an agricultural map depicting one or more crops as present with respect to a subject agricultural area. For example, the agricultural map may include GPS coordinate information corresponding to one or more sections of the agricultural area, as well as one or more corresponding crops and/or vegetation items present with respect to each section of the one or more sections of the agricultural area. In general, navigational apparatus 140 is configured to enable determination of (i) a current location of the framework 100 and a plurality of historical locations of the framework 100, and (ii) subject vegetation associated with the current location of the framework 100. Identifying the location in this manner may aid the vegetation detection/identification process, as location-based vegetation/crop information can be used to inform the image processing, particularly in cases where a plant’s identity is not clear from the subject image. For example, if the detection model 170 identifies two possible vegetation subjects in an image, hereinafter “Plant A” and “Plant B”, the agricultural map may reveal that crops of Plant B have been planted in the section corresponding to the current location of the framework 100, and as such, the depicted vegetation subject is more likely to be Plant B.

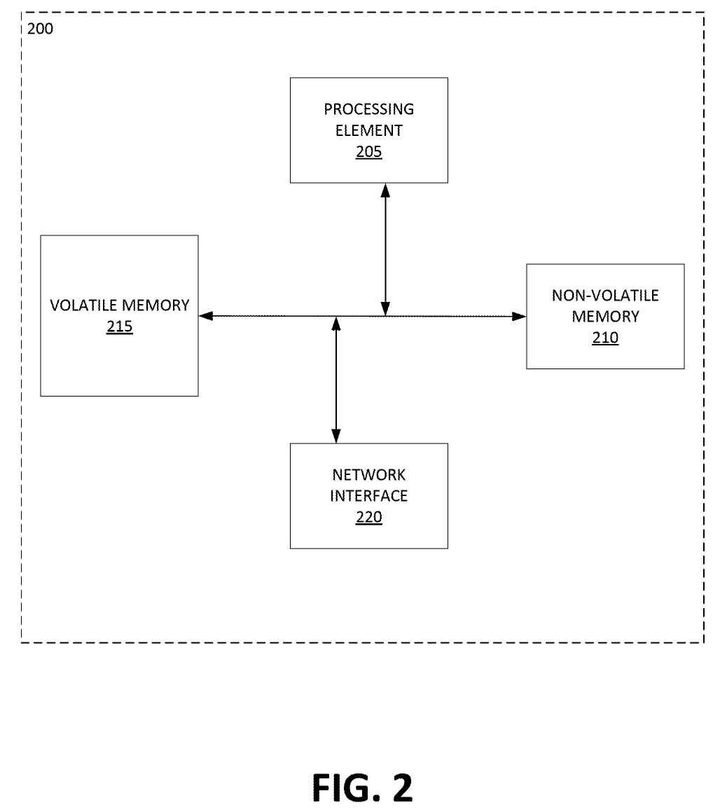

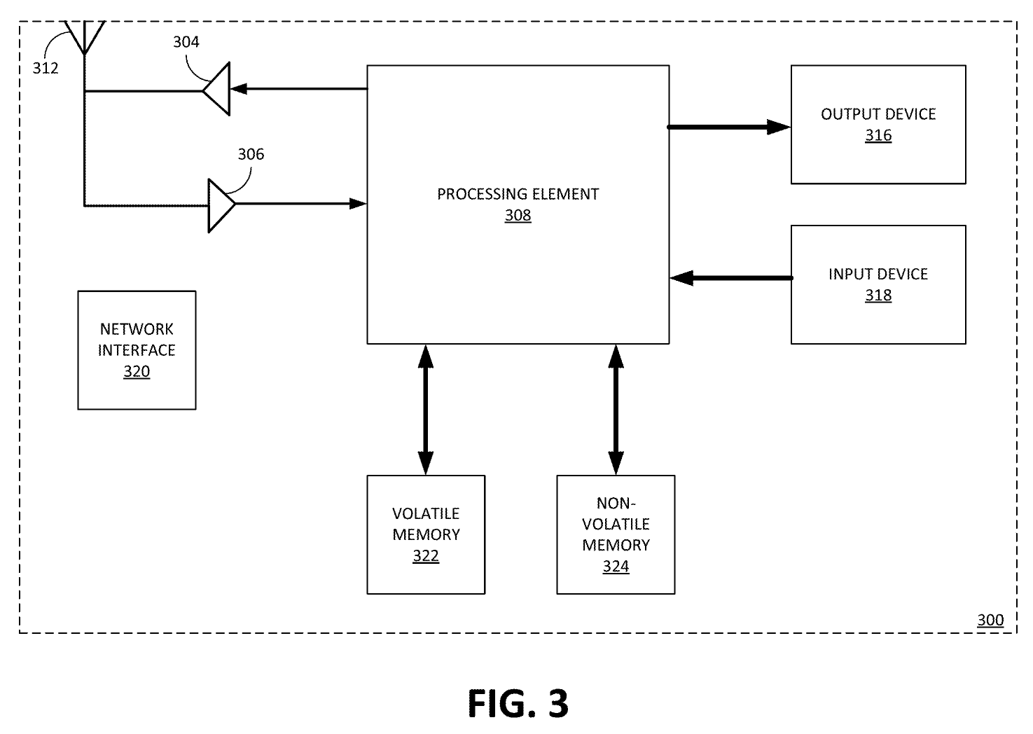

As illustrated in FIG. l, a computing system 150 is provided to interact with and/or control the various additional components, including the capture apparatus 120, the sprayer apparatus 130, and the navigational apparatus 140. As depicted, computing system 150 includes an image processing module 160, a detection model 170, and a control module 180. It should be appreciated that, though image processing module 160, detection model 170, and control module 180 are depicted as separate modules/components, many appropriate embodiments of computing system 150 exist in which these components and/or the functions of these features are combined in various arrangements. For example, detection model 170 may be configured as a part of image processing module 160, such that subject detection as provided by the detection model 170 is executed by the image processing module 160, either simultaneously with the image processing mechanisms or subsequent to the image processing. In various embodiments, the computing system 150 comprises one or more general purpose computer systems or upgraded computer systems and may correspond to computing entity 200 as described with respect to FIG. 2 and/or computing entity 300 as described with respect to FIG. 3.

Image processing module 160 may be configured to process the image data captured by/received via capture apparatus 120. In at least some embodiments, image processing module 160 is configured to implement a number of defined operations to prepare a captured image and/or image data for processing by detection model 170. Image processing module 160 may include (i) an image processing API configured to define operations using which other components can create, manipulate, configure, and execute various image processing algorithms, and (ii) a runtime component configured to manage configuration and execution of image processing algorithms, dynamically allocate memory for buffers needed during execution, interface the various components in the architecture, and manage any library of pre-defined image processing algorithms. Image processing module 160 may be configured for a plurality of image processing operations, including, but not limited to, preprocessing operations configured to prepare the image for further processing (e.g., noise reduction, image resizing, histogram equalization, color space conversion, and the like), enhancement operations configured to improve the visual quality of an image (e.g., sharpening, contrast enhancement, brightness adjustment, color correction, and the like), transformation operations configured to change the image’s structure or appearance (e.g., image rotation, image translation, image scaling, morphological operations, and the like), analysis operations configured to extract information from the image (e.g., edge detection, segmentation, feature extraction, and the like), thresholding operations, Gaussian Blur operations, Wavelet Transform operations, and compression operations, among others. In general, image processing module 160 is configured to process an image/image data captured by capture apparatus 120 to prepare the image/image data for analysis by detection model 170.

Detection model 170 may be configured to detect subject vegetation items depicted within the captured image/image data. In at least some embodiments, detection model 170 includes an object detection model configured to detect objects depicted within an image. Detection model 170 may correspond to deep learning methods leveraging convolutional neural networks (CNNs) for automatic feature extraction and object detection. In at least some embodiments, detection model 170 leverages scale-invariant feature transform techniques to identify key points and descriptors in images to identify subject vegetation. In at least some embodiments, detection model 170 leverages histogram of oriented gradients techniques configured to extract gradient orientation information from an image to represent edges and shapes. Detection model 170 may be configured to leverage deformable part models configured to model objects as a combination of parts, allowing for flexible object localization and shape variations.

In at least some embodiments, detection model 170 is configured to leverage support vector machines for classifying features extracted from images. Detection model 170 may be configured to leverage region-based convolutional neural network (R-CNN) techniques configured for using region proposals and CNNs for object detection. In at least some embodiments, detection model 170 is configured to leverage You Only Look Once (YOLO) techniques, configured as a one-stage object detector that directly predicts bounding boxes and class probabilities. In at least some embodiments, detection model 170 is configured to leverage single shot multibox detector (SSD) techniques, configured as a one-stage object detector that makes predictions at multiple scales, improving detection of objects of different sizes. Detection model 170 may be configured to leverage Mask R-CNN techniques to perform instance segmentation, thereby providing pixel-level object masks in addition to bounding boxes. In at least some embodiments, detection model 170 is configured to leverage fully convolutional one-stage object detection (FCOS) techniques, configured to provide simplified detection without requiring anchor boxes. Detection model 170 may be configured to leverage cascade R-CNN techniques configured to use a cascade of detection networks to refine predictions. In general, detection model 170 is configured to detect one or more subject vegetation items/subject vegetation types as depicted with respect to a subject image.

In at least some embodiments, detection model 170 is trained on a plurality of weed types common to a selected crop system. For example, for a first subject crop system, the detection model 170 may be trained on images of broadleaf, sedge, and grass. In general, detection model 170 may be configured to detect one or more specified vegetation types (weeds, diseased crops, and the like) to facilitate higher accuracy relative to models which may be trained according to a broader set of images which may ultimately be irrelevant to the selected crop system. In at least some embodiments, detection model 170 is a TensorRT-optimized detection model configured to identify, localize, extract information, and send the information to trigger one or more nozzles on a sprayer.

Control module 180 may be configured to receive and otherwise process information received from detection model 170 regarding the detected one or more subject vegetation items/subject vegetation types depicted with respect to the subject image. In at least some embodiments, control module 180 is configured to determine one or more appropriate spray operations associated with the detected vegetation. An appropriate spray operation may include an indication of (i) a substance to be applied by the sprayer apparatus 130, (ii) specific sprayer information indicating one or more mechanisms in the sprayer apparatus 130 which should be triggered to enable treatment of the detected vegetation, and (iii) a spray duration or spray amount for administering the spray to ensure accuracy and efficiency with respect to sprayer application(s).

### A. Example User Device

FIG. 2 provides an example computing entity 200 in accordance with some embodiments of the present disclosure. The computing entity 200 is an example of the computing system 150 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating between various computing entities such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code. Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

### B. Example External Computing Entity

FIG. 3 provides an example computing entity 300 in accordance with some embodiments of the present disclosure. In general, FIG. 3 may be representative of components of any of the modules/systems described herein generally enabling processing within each component and communication between the components. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. As shown in FIG. 3, the computing entity 300 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly. Generally, computing entity 300 may be an example of the computing system 150 of FIG. 1.

The signals provided to and received from the transmitter 304 and the receiver 306, correspondingly, may include signaling information/data in accordance with air interface standards of applicable wireless systems. In this regard, the computing entity 300 may be capable of operating with one or more air interface standards, communication protocols, modulation types, and access types. More particularly, the computing entity 300 may operate in accordance with any of a number of wireless communication standards and protocols, such as those described above with regard to the computing entity 200. In some embodiments, the computing entity 300 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the computing entity 300 may operate in accordance with multiple wired communication standards and protocols, such as those described above with regard to the computing entity 200 via a network interface 320.

Via these communication standards and protocols, the computing entity 300 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The computing entity 300 may also download code, changes, add-ons, and updates, for instance, to its firmware, software (e.g., including executable instructions, applications, program modules), and operating system.

The computing entity 300 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the computing entity 300 to interact with and/or cause display of information/data from the computing entity 200, as described herein. The user input interface may comprise any of a plurality of input devices 318 (or interfaces) allowing the computing entity 300 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the computing entity 300 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The computing entity 300 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more computer functions described herein, executable instructions, and/or the like to implement the functions of the computing entity 300. As indicated, this may include a user application that is resident on the computing entity 300 or accessible through a browser or other user interface for communicating with the computing entity 200 and/or various other computing entities.

In another embodiment, the computing entity 300 may include one or more components or functionalities that are the same or similar to those of the computing entity 200, as described in greater detail above. As will be recognized, these architectures and descriptions are provided for example purposes only and are not limited to the various embodiments.

In various embodiments, the computing entity 300 may be embodied as an artificial intelligence (AI) computing entity. Accordingly, the computing entity 300 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

Referring now to FIG. 4A, a first angle of the example smart sprayer system 400 is depicted. As depicted, the smart sprayer system 400 includes a capture device 402, one or more tires 404, and a sprayer tank 406. The smart sprayer system 400 is configured to operate along a raised plasticulture bed 408 as depicted. FIG. 4A depicts a first view of the smart sprayer system 400. Referring now to FIG. 4B, a second angle of the example smart sprayer system 400 is depicted. As depicted, the smart sprayer system 400 includes a capture device 402, one or more tires 404, a sprayer tank 406, and one or more sprayer mechanisms 410. The smart sprayer system 400 is configured to operate along a raised plasticulture bed 408 as depicted. FIG. 4B depicts a second view of the smart sprayer system 400.

In at least some embodiments, the smart sprayer system 400 as depicted with respect to FIGS. 4A and 4B is a robotic sprayer apparatus comprising one or more tires configured to navigate difficult terrain, a plurality of electronic components configured to power and control the robotic sprayer apparatus, a framework configured to accommodate raised plasticulture beds, one or more image capture devices mounted on the framework, one or more electronically controlled sprayer nozzles, one or more DC pumps and proportional control valves, and a computing unit configured to process real-time imagery and control spraying operations. Smart sprayer system 400 may include a base platform comprising electrical and electronic components, wherein said components are laid out in a structured manner with safety blocks (such as circuit breakers for all loads, for example) to allow the components to safely draw power from a connected battery.

In at least some embodiments, up to each tire of the one or more tires may comprise a wide, low-pressure tire to prevent sinking into loose sandy soil. The one or more tires may comprise a wide footprint to distribute the weight of the smart sprayer system 400 over a larger surface area, thereby reducing ground pressure. In some embodiments, the one or more tires may comprise an aggressive tread pattern. The aggressive tread pattern may feature deep, widely spaced lugs or paddle-style treads to provide traction in loose, shifting soil while allowing sand or dirt to be expelled from the tread voids during rotation. In some embodiments, the one or more tires may comprise a flotation tire optimized for sandy conditions via a rounded profile and flexible sidewalls that allow the tire to “float” on soft surfaces rather than digging in. The one or more tires may comprise a self-cleaning tread geometry, leveraging open tread patterns with tapered lugs to prevent soil/sand accumulation that would otherwise reduce traction over time. In some embodiments, the one or more tires may comprise a durable, UV-resistant rubber compound to resist degradation from prolonged sun exposure and moisture.

In some embodiments, the plurality of electronic components comprises a processing unit running a TensorRT-optimized detection model configured to identify, localize, extract information, and send information to trigger one or more nozzles. In some embodiments, the detection model is capable of achieving 22-25 frames per second for real-time detection and localization. The processing unit may be configured to trigger the nozzles in 40-45 milliseconds, enabling improved response time for triggering spray application responsive to detecting and/or identifying a subject.

In some embodiments, the plurality of electronic components comprises one or more pump control components. The pump control components may comprise multiple DC pumps controlled through pulse width modulation (PWM) signals, thereby enabling low cost, ease of control, reliability, scalability, maintenance simplicity, and operational efficiency relative to existing pump control techniques. In some embodiments, the pump control components comprise proportional-integral (PI) controllers for one or more pumps, enabling synchronized operation that reduces the pumps’ duty cycle(s) under idle conditions to less than 3 % while maintaining high precision during activation.

In some embodiments, the plurality of electronic components comprises one or more remote operation components. The one or more remote operation components may comprise a remote-control receiver and associated electronics enabling the smart sprayer system 400 to be driven independently using a remote control.

Up to each of the plurality of electronic components may be selected or configured to withstand environmental stressors (extreme heat, humidity, and windy conditions) without compromising performance.

In some embodiments, the smart sprayer system 400 is configured with a framework designed for vegetables (e.g., peppers and tomatoes) grown on raised plasticulture beds and row middles. The framework may comprise a chassis with sufficient ground clearance to straddle or navigate alongside the raised beds without damaging a plastic mulch covering. In some embodiments, the framework is configured to handle weeds on the edge of the raised plasticulture beds. To do so, the framework may comprise a boom positioning for one or more sprayers or nozzles that can target the bed edges and the row middles where weeds commonly emerge.

In some embodiments, the framework comprises dynamic height adjustment capabilities, thereby enabling flexibility for different operational scenarios by allowing the height of the spray application to be modified based on crop requirements. The framework may comprise adjustable mounting points or actuated boom arms to accommodate varying bed heights and crop canopy levels.

In some embodiments, the framework comprises imaging sensors at optimal angles to capture weeds along the bed edges and in row middles. The framework may comprise a framework-mounted imaging system and processing hardware supporting a TensorRT-optimized detection model for near-real-time detection.

In some embodiments, the framework comprises framework-integrated spray nozzles configured to maintain consistent pressure during operation. In doing so, the framework enables a uniform spray pattern even under windy conditions. The framework may be optimized for minimal drift, thereby reducing herbicide wastage and off-target impacts.

In some embodiments, the one or more image capture devices mounted on the framework may comprise one or more industrial-grade digital cameras. Up to each digital camera may comprise a lens assembly with a field of view configured to capture weeds on the edge of the plasticulture beds and row middles. The smart sprayer system 400 may further comprise a high-speed data interface connecting the one or more image capture devices to an onboard processing/computing unit, thereby enabling the system to identify, localize, extract information, and trigger the nozzles quickly (e.g., within 40-45 milliseconds).

In some embodiments, the one or more image capture devices comprise a sealed enclosure surrounding the camera sensor and lens assembly configured to protect the camera from environmental stressors without compromising performance. For example, the one or more image capture devices may comprise weather-resistant sealing configured to protect internal operation in extreme heat, humidity, windy conditions, and/or the like. In some embodiments, the one or more image capture devices comprise an optical window or lens cover made of scratch-resistant, optically clear material to maintain image quality while protecting the lens from dust, debris, and moisture.

In some embodiments, the one or more image capture devices are attached to the framework of the smart sprayer system 400 via a mounting assembly. The mounting assembly may comprise a bracket or mounting arm securing an image capture device to the framework at a fixed or adjustable angle oriented toward the bed edges and row middles. In some embodiments, the mounting assembly comprises an adjustment mechanism compatible with the system’s dynamic height adjustment capability, thereby enabling camera positioning to be modified when the height of spray application is modified based on crop requirements. In some embodiments, the mounting assembly comprises vibration-dampening elements to maintain stable image capture as the system navigates potentially difficult terrain associated with agricultural farms.

In some embodiments, up to each sprayer nozzle of the one or more electronically controlled sprayer nozzles comprises an orifice configured to generate a spray pattern optimized for minimal drift. Up to each nozzle may comprise an electronically actuated valve mechanism responsive to one or more trigger signals. In some embodiments, up to each sprayer nozzle comprises a proportional valve enabling variable flow rates based on detection signals from the computing unit/processing unit. In some embodiments, a PI controller is connected to both pumps and proportional valves provide synchronized actuation that reduces the pumps’ duty cycle.

In some embodiments, up to each sprayer nozzle comprises one or more pressure regulation components. The one or more pressure regulation components may comprise pressure regulation hardware within or upstream of a corresponding nozzle assembly. In some embodiments, the one or more pressure regulation components comprise flow regulation components enabling the nozzle to maintain pressure within 5 % of a target pressure, thereby minimizing off-target application.

In some embodiments, up to each sprayer nozzle of the one or more electronically controller sprayer nozzles comprises fluid inlet fittings connecting the nozzle to a supply manifold fed by one or more DC pumps that provide solution under controlled pressure. The sprayer nozzle(s) may be connected to various additional components via one or more supply lines constructed from materials suitable for operation in extreme heat, humidity, and windy conditions, for example.

In some embodiments, the one or more DC pumps may comprise a DC motor coupled to a pump mechanism. Up to each pump may include electrical terminals configured to receive PWM control signals from the control electronics, thereby enabling variable speed operation for precise flow management. In some embodiments, fluid inlet and outlet ports connect up to each pump to a supply reservoir and a distribution manifold configured to feed the sprayer nozzles.

In some embodiments, the proportional control valves are positioned within the fluid distribution system for precise flow regulation. Up to each proportional control valve may comprise an electronically actuated valve body with a variable orifice controlled by an electromagnetic actuator or stepper motor. In some embodiments, up to each proportional control valve comprises one or more electrical connections to receive control signals for both pumps and proportional valves, thereby enabling the system to achieve synchronized operation.

In some embodiments, the smart sprayer system 400 includes a computing unit mounted on the framework and configured to process real-time imagery and control spraying operations. The computing unit may comprise a central processing unit or embedded computing platform configured to execute a TensorRT-optimized detection model, achieving 22-25 FPS, ensuring real-time detection and localization. The computing unit may further comprise a graphics processing unit or dedicated neural network accelerator compatible with TensorRT optimization, providing the computational throughput necessary to identify, localize, extract information, and send the information to trigger the nozzles.

The computing unit may comprise onboard memory modules storing a customized detection model trained on three distinct weed types common in these crop systems: broadleaf, sedge, and grass. One or more high-speed camera interfaces receive image data from the mounted image capture devices. Digital output ports are configured to transmit trigger signals to the sprayer nozzles and valve actuators, enabling the 40-45 millisecond response pipeline.

The computing unit may comprise PWM signal output channels connected to the plurality of DC pumps. Control signal interfaces communicate with the PI controllers for both pumps and proportional valves, enabling synchronized operation of the fluid delivery system.

In some embodiments, the computing unit executes embedded firmware or software modules implementing PI controllers, whereby the system achieves synchronized operation, reducing the pumps’ duty cycle under idle conditions to less than 3 % and maintaining high precision during activation. Control algorithms executed by the computing unit are configured to achieve a fast response time, ensuring timely application with minimal delay. The control algorithms further maintain an overshoot of less than 15 %, minimizing herbicide over-application. Pressure monitoring and regulation routines enable the system to maintain pressure within ±5 % of the target during spraying operations.

The computing unit may comprise a wireless communication module enabling remote operation, as the existing system can either be driven independently using a remote control or attached to a tractor. In some embodiments, a sealed enclosure houses the computing hardware, constructed from materials selected for their ability to withstand environmental stressors without compromising performance.

The base platform comprising electrical and electronic components, wherein said components are laid out in a structured manner with safety blocks (such as circuit breakers for all loads, for example) to allow the components to safely draw power from a connected battery.

In at least some embodiments, the battery may be a 48V 100A battery. In at least some embodiments, the individual electrical and electronic components are placed on acrylic sheets with a raised setup (including nylon spacers, for example) to prevent contact with the base platform. Utilization of a raised setup in this manner may additionally prevent the components from exposure to high heat during field operations. In at least some embodiments, the smart sprayer system 400 includes a top hood configured to protect some, if not all, of the electronic components (such as circuit breakers, voltage converters, motor drivers, receivers, and the like) and the electrical/hydraulic components of the sprayer apparatus (pumps, check valves, pressure transducers, and the like) from external environmental factors such as wind, heat, and rain. In at least some embodiments, the smart sprayer system 400 includes a rear hood configured to protect additional components (main pipe, pressure gauge, nozzles, solenoids, and the like) from external environmental factors. In at least some embodiments, a partition between pumps, backflow check valves, and other electrical/electronic components of the smart sprayer system 400 prevents water leaks or moisture from affecting the electrical/electronic components.

### IV. Examples of Certain Terms

In some embodiments, the terms “user system,” “user device,” “user computing device,” “user computing entity,” and the like may refer to any system configured to control and/or interact with an AI-enabled smart sprayer system as described herein. In general, the user system may refer to any system capable of providing an interface to a user device via which a user can interact with a smart sprayer system application. User systems as described herein enable a user to view and/or interact with one or more selectable features corresponding to an AI-enabled smart sprayer system.

In some embodiments, the terms “agricultural subject,” “subject plant,” “subject crop,” “vegetation subject,” and the like refer to one or more plants or plant types which are detected using a detection model as described herein. In at least some embodiments, agricultural subjects refer to plants such as weeds which an AI-enabled smart sprayer system as described herein is configured to remove, minimize, and/or otherwise manage. In general, agricultural subjects refer to plants identified within images captured by the capture system.

In some embodiments, the terms “agricultural area,” “crop area,” “agricultural section,” “crop section,” “vegetation area,” and the like refer to an area of vegetation managed using the AI-enabled smart sprayer system embodiments as described herein. An agricultural section may correspond to a part of a larger agricultural area; the smart sprayer systems as described herein may be configured with operational instructions which differ from section to section to accommodate different plant growth in each section.

### V. Example System Operations

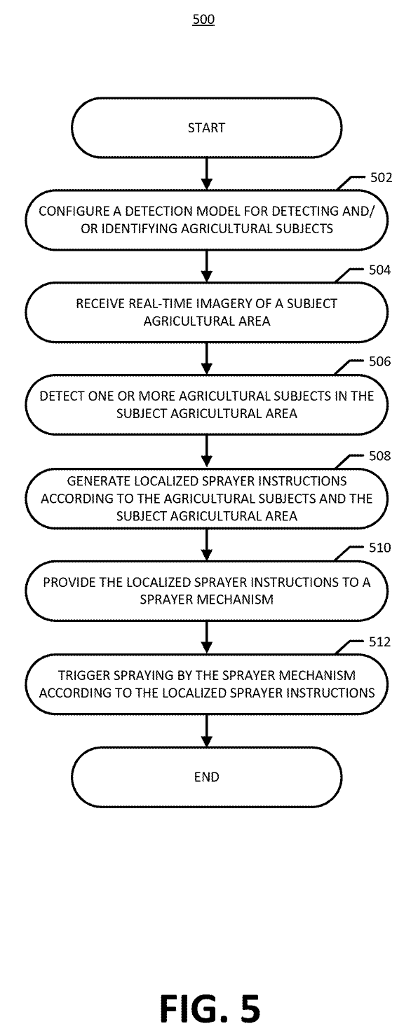

FIG. 5 depicts an example process 500 for managing sprayer operation in accordance with at least some example embodiments of the present disclosure. As depicted, example process 500 includes configuring (502) a detection model for detecting and/or identifying agricultural subjects, receiving (504) real-time imagery of a subject agricultural area, detecting (506) one or more agricultural subjects in the subject agricultural area, generating (508) localized sprayer instructions according to the agricultural subjects and the subject agricultural area, providing (510) the localized sprayer instructions to a sprayer mechanism, and triggering (512) spraying by the sprayer mechanism according to the localized sprayer instructions. Example process 500 may enable control of a smart sprayer system in accordance with at least some embodiments of the present disclosure.

At step 502, computing system 150 configures a detection model for detecting and/or identifying agricultural subjects. Configuring (502) a detection model for detecting and/or identifying agricultural subjects may include training an object detection model for detecting objects within one or more images. In at least some embodiments, configuring (502) a detection model for detecting and/or identifying agricultural subjects includes receiving a plurality of labeled images corresponding to one or more target agricultural subjects. Configuring (502) a detection model for detecting agricultural subjects includes training the detection model according to the labeled images corresponding to the one or more target agricultural subjects. In at least some embodiments, the target agricultural subjects may include one or more plants and/or plant types which a subject smart prayer system is configured to manage. In at least some embodiments, configuring (502) a detection model for detecting and/or identifying agricultural subjects includes training the detection model on a plurality of weed types common to a selected crop system. For example, for a first subject crop system, the detection model may be trained on images of broadleaf, sedge, and grass. In general, detection model may be configured to detect one or more specified vegetation types (such as vegetables including peppers and tomatoes, weeds, diseased crops, and the like) to facilitate higher accuracy relative to models which may be trained according to a broader set of images which may ultimately be irrelevant to the selected crop system. In at least some embodiments, detection model is a TensorRT-optimized detection model configured to identify, localize, extract information, and send the information to trigger one or more nozzles on a sprayer.

At step 504, computing system 150 receives real-time imagery of a subject agricultural area. Receiving (504) real-time imagery of a subject agricultural area may include receiving one or more images from a capture apparatus configured to capture images associated with an agricultural area serviced by the subject smart sprayer system. In at least some embodiments, receiving (504) real-time imagery of a subject agricultural area includes receiving a video feed from the capture apparatus. In at least some embodiments, receiving (504) real-time imagery of a subject agricultural area includes receiving raw image data from the capture apparatus. Receiving (504) real-time imagery of a subject agricultural area may include receiving processed images corresponding to the subject agricultural area. In at least some embodiments, receiving (504) real-time imagery of a subject agricultural area includes receiving location information corresponding to the capture apparatus and/or the subject smart sprayer system’s location at the time of the image capture. Receiving (504) real-time imagery of a subject agricultural area may include tagging the received imagery with the received location information. In at least some embodiments, the computing system 150 is configured to determine location information associated with the received imagery based, at least in part, on an expected location associated with the subject smart sprayer system’s route for spraying the agricultural area.

At step 506, computing system 150 detects one or more agricultural subjects in the subject agricultural area. Detecting (506) one or more agricultural subjects in the subject agricultural area may include leveraging an object detection model configured to detect objects depicted within the received real-time imagery. An appropriate detection model may include deep learning methods leveraging convolutional neural networks (CNNs) for automatic feature extraction and object detection. In at least some embodiments, detecting (506) one or more agricultural subjects in the subject agricultural area includes leveraging scale-invariant feature transform techniques to identify key points and descriptors in images to identify subject vegetation. In at least some embodiments, detecting (506) one or more agricultural subjects in the subject agricultural area includes leveraging histogram of oriented gradients techniques configured to extract gradient orientation information from an image to represent edges and shapes. In at least some embodiments, detecting (506) one or more agricultural subjects I the subject agricultural area includes leveraging deformable part models configured to model objects as a combination of parts, allowing for flexible object localization and shape variations.

In at least some embodiments, detecting (506) one or more agricultural subjects in the subject agricultural area includes leveraging support vector machines for classifying features extracted from images. In at least some embodiments, detecting (506) one or more agricultural subjects in the subject agricultural area includes leveraging region-based convolutional neural network (R-CNN) techniques configured for using region proposals and CNNs for object detection. In at least some embodiments, detecting (506) one or more agricultural subjects in the subject agricultural area includes leveraging You Only Look Once (YOLO) techniques, configured as a one-stage object detector that directly predicts bounding boxes and class probabilities. In at least some embodiments, detecting (506) one or more agricultural subjects in the subject agricultural area includes leveraging single shot multibox detector (SSD) techniques, configured as a one-stage object detector that makes predictions at multiple scales, improving detection of objects of different sizes. In at least some embodiments, detecting (506) one or more agricultural subjects in the subject agricultural area includes leveraging Mask R-CNN techniques to perform instance segmentation, thereby providing pixel-level object masks in addition to bounding boxes. In at least some embodiments, detecting (506) one or more agricultural subjects in the subject agricultural area includes leveraging fully convolutional one-stage object detection (FCOS) techniques, configured to provide simplified detection without requiring anchor boxes. In at least some embodiments, detecting (506) one or more agricultural subjects in the subject agricultural area includes leveraging cascade R-CNN techniques configured to use a cascade of detection networks to refine predictions.

At step 508, the computing system 150 generates localized sprayer instructions according to the agricultural subjects and the subject agricultural area. Generating (508) localized sprayer instructions according to the agricultural subjects and the subject agricultural area may include determining where the detected one or more agricultural subjects are located relative to the subject smart sprayer system. For example, generating (508) localized sprayer instructions according to the agricultural subjects and the subject agricultural area may include determining one or more individual sprayer mechanisms of the larger sprayer apparatus which are configured to administer spray to a location of the agricultural subject. For a smart sprayer system with six nozzles labeled 1-6, for example, generating (508) localized sprayer instructions according to the agricultural subjects may include determining that the agricultural subject is located in an area services by nozzle 2. As such, the localized sprayer instructions will instruct nozzle 2 to activate during a timeframe associated with the agricultural subject (e.g., the timeframe during which the subject smart sprayer system will pass over the agricultural subject). In at least some embodiments, generating (508) localized sprayer instructions may include determining, based on current speed and/or location information of the subject smart sprayer system and a route plan associated with the subject smart sprayer system, a timeframe during which the spray should be administered to treat the agricultural subject.

In some embodiments, generating (508) localized sprayer instructions according to the agricultural subjects and the subject agricultural area includes determining an optimized pressure for sprayer application with respect to the agricultural subjects and the subject agricultural area. For example, generating (508) localized sprayer instructions may comprise identifying an optimized pressure which ensures a uniform spray pattern with respect to a set of given conditions (e.g., wind, precipitation, and the like). The optimized pressure may be determined to minimize drift, thereby reducing herbicide wastage and off-target impacts.

In some embodiments, generating (508) localized sprayer instructions may comprise (i) setting a pre-determined pressure to control the flow rate of a sprayer mechanism, (ii) controlling the pressure/flow rate of a corresponding pump, (iii) controlling opening and closing of a proportional control valve, and (iv) getting real-time feedback from a pressure transducer. Generating (508) localized sprayer instructions may further comprise generating instructions to control the pressure/flow rate of the pump and the opening/closing of the proportional control valve based on the real-time feedback from the pressure transducer. In doing so, the pressure of the sprayer mechanism may be controlled autonomously.

In some embodiments, generating (508) localized sprayer instructions according to the agricultural subjects and the subject agricultural area includes determining an optimized spray application height for the agricultural subjects and the subject agricultural area. For example, generating (508) the localized sprayer instructions may include determining an optimal placement for a movable sprayer nozzle and/or an optimal positioning angle for the sprayer nozzle to enable an optimal spray height. The optimal spray height may ensure that the nozzle positioning enables the spray to reach the agricultural subjects and the subject agricultural area with minimal drift and overshoot.

At step 510, computing system 150 provides the localized sprayer instructions to a sprayer mechanism. In at least some embodiments, providing (510) the localized sprayer instructions to a sprayer mechanism may include instructing a sprayer mechanism to activate upon reaching a subject location and/or timeframe associated with the agricultural subject. In at least some embodiments, providing (510) the localized sprayer instructions to a sprayer mechanism includes providing a timeline for operation to a control module of the sprayer mechanism according to which the sprayer mechanism will activate and deactivate. Providing (510) the localized sprayer instructions to a sprayer mechanism may include transmitting the sprayer instructions to the sprayer mechanism, thereby configuring the sprayer mechanism for operation in accordance with the localized sprayer instructions.

At step 512, computing system 150 triggers spraying by the sprayer mechanism according to the localized sprayer instructions. Triggering (512) spraying by the sprayer mechanism according to the localized sprayer instructions may include instructing a sprayer mechanism to activate upon reaching a subject location and/or timeframe associated with the agricultural subject. In general, triggering (512) spraying by the sprayer mechanism includes causing release of the substance administered by the subject smart sprayer system upon detection of the appropriate time and/or location associated with the agricultural subject.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method comprising configuring a detection model configured to detect at least one target agricultural subject. The method includes receiving real-time imagery depicting a subject agricultural area serviced by a sprayer system comprising a plurality of sprayer mechanisms. The method includes detecting at least one depicted target agricultural subject in the real-time imagery depicting the subject agricultural area. The method includes generating one or more localized sprayer instructions according to the at least one depicted target agricultural subject and the subject agricultural area, wherein the one or more localized sprayer instructions comprise an optimized pressure and an optimized application height associated with the sprayer system. The method includes providing the one or more localized sprayer instructions to at least one sprayer mechanism. The method includes causing activation of the at least one sprayer mechanism of the plurality of sprayer mechanisms based at least in part on the one or more localized sprayer instructions.

Example 2. The computer-implemented method of Example 1, wherein detecting the at least one depicted target agricultural subject in the real-time imagery depicting the subject agricultural area includes training an object detection model to analyze the real-time imagery depicting the subject agricultural area.

Example 3. The computer-implemented method of any of the preceding Examples, wherein training the object detection model to analyze the real-time imagery depicting the subject agricultural area includes training the object detection model using a plurality of labeled training images of the at least one target agricultural subject.

Example 4. The computer-implemented method of any of the preceding Examples, wherein generating the one or more localized sprayer instructions according to the at least one depicted target agricultural subject and the subject agricultural area includes determining a location associated with the at least one depicted target agricultural subject in the real-time imagery depicting the subject agricultural area.

Example 5. The computer-implemented method of any of the preceding Examples, wherein generating the one or more localized sprayer instructions according to the at least one depicted target agricultural subject and the subject agricultural area includes generating instructions to activate the at least one sprayer mechanism of the plurality of sprayer mechanisms associated with the location associated with the at least one depicted agricultural subject.

Example 6. The computer-implemented method of any of the preceding examples, wherein generating the one or more localized sprayer instructions according to the at least one depicted target agricultural subject and the subject agricultural area includes generating instructions to activate the at least one sprayer mechanism of the plurality of sprayer mechanisms at a predicted time at which the sprayer system is predicted to reach the at least one depicted target agricultural subject.

Example 7. The computer-implemented method of any of the preceding examples, wherein the sprayer system is a robotic sprayer apparatus comprising one or more tires configured to navigate difficult terrain, a plurality of electronic components configured to power and control the robotic sprayer apparatus, a framework configured to accommodate raised plasticulture beds, one or more image capture devices mounted on the framework, one or more electronically controlled sprayer nozzles, one or more DC pumps and proportional control valves, and a computing unit configured to process real-time imagery and control spraying operations.

Example 8. A computing apparatus comprising memory and one or more processors communicatively coupled to the memory, the one or more processors configured to perform operations comprising: configuring a detection model configured to detect at least one target agricultural subject; receiving real-time imagery depicting a subject agricultural area serviced by a sprayer system comprising a plurality of sprayer mechanisms; detecting at least one depicted target agricultural subject in the real-time imagery depicting the subject agricultural area; generating one or more localized sprayer instructions according to the at least one depicted target agricultural subject and the subject agricultural area, wherein the one or more localized sprayer instructions comprise an optimized pressure and an optimized application height associated with the sprayer system; providing the one or more localized sprayer instructions to a sprayer mechanism; and causing activation of at least one sprayer mechanism of the plurality of sprayer mechanisms based at least in part on the one or more localized sprayer instructions.

Example 9. The computing apparatus of example 8, wherein detecting the at least one depicted target agricultural subject in the real-time imagery depicting the subject agricultural area includes training an object detection model to analyze the real-time imagery depicting the subject agricultural area.

Example 10. The computing apparatus of any of the preceding examples, wherein training the object detection model to analyze the real-time imagery depicting the subject agricultural area includes training the object detection model using a plurality of labeled training images of the at least one target agricultural subject.

Example 11. The computing apparatus of any of the preceding examples, wherein generating the one or more localized sprayer instructions according to the at least one depicted target agricultural subject and the subject agricultural area includes determining a location associated with the at least one depicted target agricultural subject in the real-time imagery depicting the subject agricultural area.

Example 12. The computing apparatus of any of the preceding examples, wherein generating the one or more localized sprayer instructions according to the at least one depicted target agricultural subject and the subject agricultural area includes generating instructions to activate the at least one sprayer mechanism of the plurality of sprayer mechanisms associated with the location associated with the at least one depicted agricultural subject.

Example 13. The computing apparatus of any of the preceding examples, wherein generating the one or more localized sprayer instructions according to the at least one depicted target agricultural subject and the subject agricultural area includes generating instructions to activate the at least one sprayer mechanism of the plurality of sprayer mechanisms at a predicted time at which the sprayer system is predicted to reach the at least one depicted target agricultural subject.

Example 14. The computing apparatus of any of the preceding examples, wherein the sprayer system is a robotic sprayer apparatus comprising one or more tires configured to navigate difficult terrain, a plurality of electronic components configured to power and control the robotic sprayer apparatus, a framework configured to accommodate raised plasticulture beds, one or more image capture devices mounted on the framework, one or more electronically controlled sprayer nozzles, one or more DC pumps and proportional control valves, and a computing unit configured to process real-time imagery and control spraying operations.

Example 15. One or more non-transitory computer-readable storage media including instructions that, when executed by one or more processors, cause the one or more processors to perform operations comprising: configuring a detection model configured to detect at least one target agricultural subject; receiving real-time imagery depicting a subject agricultural area serviced by a sprayer system comprising a plurality of sprayer mechanisms; detecting at least one depicted target agricultural subject in the real-time imagery depicting the subject agricultural area; generating one or more localized sprayer instructions according to the at least one depicted target agricultural subject and the subject agricultural area, wherein the one or more localized sprayer instructions comprise an optimized pressure and an optimized application height associated with the sprayer system; providing the one or more localized sprayer instructions to a sprayer mechanism; and causing activation of at least one sprayer mechanism of the plurality of sprayer mechanisms based at least in part on the one or more localized sprayer instructions.

Example 16. The one or more non-transitory computer-readable storage media of example 15, wherein detecting the at least one depicted target agricultural subject in the real-time imagery depicting the subject agricultural area includes training an object detection model to analyze the real-time imagery depicting the subject agricultural area.

Example 17. The one or more non-transitory computer-readable storage media of any of the preceding examples, wherein training the object detection model to analyze the real-time imagery depicting the subject agricultural area includes training the object detection model using a plurality of labeled training images of the at least one target agricultural subject.

Example 18. The one or more non-transitory computer-readable storage media of any of the preceding examples, wherein generating the one or more localized sprayer instructions according to the at least one depicted target agricultural subject and the subject agricultural area includes determining a location associated with the at least one depicted target agricultural subject in the real-time imagery depicting the subject agricultural area.

Example 19. The one or more non-transitory computer-readable storage media of any of the preceding examples, wherein generating the one or more localized sprayer instructions according to the at least one depicted target agricultural subject and the subject agricultural area includes generating instructions to activate the at least one sprayer mechanism of the plurality of sprayer mechanisms associated with the location associated with the at least one depicted agricultural subject.

Example 20. The one or more non-transitory computer-readable storage media of any of the preceding examples, wherein generating the one or more localized sprayer instructions according to the at least one depicted target agricultural subject and the subject agricultural area includes generating instructions to activate the at least one sprayer mechanism of the plurality of sprayer mechanisms at a predicted time at which the sprayer system is predicted to reach the at least one depicted target agricultural subject.

1. A computer-implemented method comprising:
configuring, by one or more processors, a detection model configured to detect at least one target agricultural subject;
receiving, by the one or more processors, real-time imagery depicting a subject agricultural area serviced by a sprayer system comprising a plurality of sprayer mechanisms;
detecting, by the one or more processors, at least one depicted target agricultural subject in the real-time imagery depicting the subject agricultural area;
generating, by the one or more processors, one or more localized sprayer instructions according to the at least one depicted target agricultural subject and the subject agricultural area, wherein the one or more localized sprayer instructions comprise an optimized pressure and an optimized application height associated with the sprayer system;
providing, by the one or more processors, the one or more localized sprayer instructions to at least one sprayer mechanism of the plurality of sprayer mechanisms; and
causing, by the one or more processors, activation of the at least one sprayer mechanism of the plurality of sprayer mechanisms based at least in part on the one or more localized sprayer instructions.

2. The computer-implemented method of claim 1, wherein detecting the at least one depicted target agricultural subject in the real-time imagery depicting the subject agricultural area includes training an object detection model to analyze the real-time imagery depicting the subject agricultural area.

3. The computer-implemented method of claim 2, wherein training the detection model to analyze the real-time imagery depicting the subject agricultural area includes training the detection model using a plurality of labeled training images of the at least one target agricultural subject.

4. The computer-implemented method of claim 1, wherein generating the one or more localized sprayer instructions according to the at least one depicted target agricultural subject and the subject agricultural area includes determining a location associated with the at least one depicted target agricultural subject in the real-time imagery depicting the subject agricultural area.

5. The computer-implemented method of claim 4, wherein generating the one or more localized sprayer instructions according to the at least one depicted target agricultural subject and the subject agricultural area includes generating instructions to activate the at least one sprayer mechanism of the plurality of sprayer mechanisms associated with the location associated with the at least one depicted target agricultural subject.

6. The computer-implemented method of claim 4, wherein generating the one or more localized sprayer instructions according to the at least one depicted target agricultural subject and the subject agricultural area includes generating instructions to activate the at least one sprayer mechanism of the plurality of sprayer mechanisms at a predicted time at which the sprayer system is predicted to reach the at least one depicted target agricultural subject.

7. The computer-implemented method of claim 1, wherein the sprayer system is a robotic sprayer apparatus comprising:
one or more tires configured to navigate difficult terrain;
a plurality of electronic components configured to power and control the robotic sprayer apparatus;
a framework configured to accommodate raised plasticulture beds;
one or more image capture devices mounted on the framework;
one or more electronically controlled sprayer nozzles;
one or more direct current (DC) pumps and corresponding proportional control valves; and
a computing unit configured to process real-time imagery and control spraying operations.

8. A computing apparatus comprising memory and one or more processors communicatively coupled to the memory, the one or more processors configured to perform operations comprising:
configuring a detection model configured to detect at least one target agricultural subject;
receiving real-time imagery depicting a subject agricultural area serviced by a sprayer system comprising a plurality of sprayer mechanisms;
detecting at least one depicted target agricultural subject in the real-time imagery depicting the subject agricultural area;
generating one or more localized sprayer instructions according to the at least one depicted target agricultural subject and the subject agricultural area, wherein the one or more localized sprayer instructions comprise an optimized pressure and an optimized application height associated with the sprayer system;
providing the one or more localized sprayer instructions to at least one sprayer mechanism of the plurality of sprayer mechanisms; and
causing activation of the at least one sprayer mechanism of the plurality of sprayer mechanisms based at least in part on the one or more localized sprayer instructions.

9. The computing apparatus of claim 8, wherein detecting the at least one depicted target agricultural subject in the real-time imagery depicting the subject agricultural area includes training a detection model to analyze the real-time imagery depicting the subject agricultural area.

10. The computing apparatus of claim 9, wherein training the detection model to analyze the real-time imagery depicting the subject agricultural area includes training the detection model using a plurality of labeled training images of the at least one target agricultural subject.

11. The computing apparatus of claim 8, wherein generating the one or more localized sprayer instructions according to the at least one depicted target agricultural subject and the subject agricultural area includes determining a location associated with the at least one depicted target agricultural subject in the real-time imagery depicting the subject agricultural area.

12. The computing apparatus of claim 11, wherein generating the one or more localized sprayer instructions according to the at least one depicted target agricultural subject and the subject agricultural area includes generating instructions to activate the at least one sprayer mechanism of the plurality of sprayer mechanisms associated with the location associated with the at least one depicted target agricultural subject.

13. The computing apparatus of claim 11, wherein generating the one or more localized sprayer instructions according to the at least one depicted target agricultural subject and the subject agricultural area includes generating instructions to activate the at least one sprayer mechanism of the plurality of sprayer mechanisms at a predicted time at which the sprayer system is predicted to reach the at least one depicted target agricultural subject.

14. The computing apparatus of claim 8, wherein the sprayer system is a robotic sprayer apparatus comprising:
one or more tires configured to navigate difficult terrain;
a plurality of electronic components configured to power and control the robotic sprayer apparatus;
a framework configured to accommodate raised plasticulture beds;
one or more image capture devices mounted on the framework;
one or more electronically controlled sprayer nozzles;
one or more direct current (DC) pumps and corresponding proportional control valves; and
a computing unit configured to process real-time imagery and control spraying operations.

15. One or more non-transitory computer-readable storage media including instructions that, when executed by one or more processors, cause the one or more processors to perform operations comprising:
configuring a detection model configured to detect at least one target agricultural subject;
receiving real-time imagery depicting a subject agricultural area serviced by a sprayer system comprising a plurality of sprayer mechanisms;
detecting at least one depicted target agricultural subject in the real-time imagery depicting the subject agricultural area;
generating one or more localized sprayer instructions according to the at least one depicted target agricultural subject and the subject agricultural area, wherein the one or more localized sprayer instructions comprise an optimized pressure and an optimized application height associated with the sprayer system;
providing the one or more localized sprayer instructions to at least one sprayer mechanism of the plurality of sprayer mechanisms; and
causing activation of the at least one sprayer mechanism of the plurality of sprayer mechanisms based at least in part on the one or more localized sprayer instructions.

16. The one or more non-transitory computer-readable storage media of claim 15, wherein detecting the at least one depicted target agricultural subject in the real-time imagery depicting the subject agricultural area includes training a detection model to analyze the real-time imagery depicting the subject agricultural area.

17. The one or more non-transitory computer-readable storage media of claim 16, wherein training the detection model to analyze the real-time imagery depicting the subject agricultural area includes training the detection model using a plurality of labeled training images of the at least one target agricultural subject.

18. The one or more non-transitory computer-readable storage media of claim 15, wherein generating the one or more localized sprayer instructions according to the at least one depicted target agricultural subject and the subject agricultural area includes determining a location associated with the at least one depicted target agricultural subject in the real-time imagery depicting the subject agricultural area.

19. The one or more non-transitory computer-readable storage media of claim 18, wherein generating the one or more localized sprayer instructions according to the at least one depicted target agricultural subject and the subject agricultural area includes generating instructions to activate the at least one sprayer mechanism of the plurality of sprayer mechanisms associated with the location associated with the at least one depicted target agricultural subject.

20. The one or more non-transitory computer-readable storage media of claim 18, wherein generating the one or more localized sprayer instructions according to the at least one depicted target agricultural subject and the subject agricultural area includes generating instructions to activate the at least one sprayer mechanism of the plurality of sprayer mechanisms at a predicted time at which the sprayer system is predicted to reach the at least one depicted target agricultural subject.
